(19) United States
(12) Patent Application Publication
(10) Pub. No.: US 2024/0151592 A1
(43) Pub. Date: May 9, 2024

(54) SMART TEMPERATURE MONITORING MICROCHIP FOR TEMPERATURE SENSITIVE PRODUCTS

(71) Applicant: WI-LAN RESEARCH INC., VISTA, CA (US)

(72) Inventors: Rashad Ramzan, Slamabad (PK); Haziq Rohail, Islamabad (PK); Zahid Abbas, Islamabad (PK); Kenneth Stanwood, Vista, CA (US)

(73) Assignee: WI-LAN RESEARCH INC., VISTA, CA (US)

(21) Appl. No.: 18/053,061

(22) Filed: Nov. 7, 2022

(51) Int. Cl. G01K 7/00; H02J 50/12; H02J 50/40; H02J 50/80

(52) U.S. Cl. CPC G01K 7/00; H02J 50/12; H02J 50/402; H02J 50/80

(57) ABSTRACT

An AC powered temperature sensing microchip is powered wirelessly through Resonant Wireless Power Transfer, sends temperature data using backscattering and hence does not require a DC rectifier circuit. It receives the AC power and uses it (without rectifying) to measure the temperature. A Band Gap Reference Oscillator is used to measure the AC signal strength that is received in a microchip and two PTAT oscillators are used to accurately measure the temperature. The outputs of these three oscillators are sent using the backscattering communication method. It can also be used for accurately measuring and communicating the temperature of subject bodies including but not limited to pharmaceutical products such as vaccines, intravenous injections, and other similar medicines. The invention described can also be used for measuring the temperature of food products, blood samples, and any other sensitive product where the continuous monitoring of temperature is a mandatory or regulatory requirement.

### FIELD OF THE INVENTION

The invention described herein discloses an ultra-low power wireless microchip for temperature monitoring of fluids, for example, pharmaceutical products such as vaccines, intravenous injections, and other similar type of medicines, that require accurate temperature monitoring of the ambient environment to maintain their efficacy and effectiveness. The scope of the invention, however, is not limited to pharmaceutical products only. Rather, it could also be used in the beverage and food industry, or any other similar industries where the transported goods require temperature monitoring.

### BACKGROUND OF THE INVENTION

Vaccines are considered the most effective intervention in modern epidemiology to control and prevent the spread of infectious diseases among people to avoid pandemic situations like CoVID19 that has been recently experienced (or being still experienced) by everyone in the world. Transporting vaccines across heterogeneous logistic networks, which typically operate in unpredictable environments, and storing them reliably under controlled ambient environment remains a significant challenge, especially when the efficacy and effectiveness of vaccines are compromised if the prescribed ambient environment is not reliably maintained (or provided for). These compromised vaccines of low efficacy may degrade the quality of protection to the vaccinated people and may also expose manufacturers to a significant amount of financial toxicity (or costs) when regulators demand destroying these vaccines.

A single box may contain several vaccine vials and is typically made of an insulating material to preserve its temperature. If it remains exposed to ambient temperatures well beyond the prescribed limit for an extended period, the ambient heat gradually starts diffusing into the box. As a result, initially the vials at the boundary of the box are exposed to an ambient temperature outside the specified range, and eventually, all vials become exposed to temperatures that may reduce the efficacy of vaccine vials or render them completely ineffective in a worst-case scenario. This heat dissipation model demonstrates that the vials, located near the perimeter of a box, would experience a relatively larger temperature for longer time duration compared to the ones located at the center of a box. The vials will, therefore, lose their efficacies at different times. It is desirable to discard only compromised vaccines, but it presents a significant challenge to verify and validate which of them are still usable in terms of their efficacy and effectiveness.

### SUMMARY OF THE INVENTION

The present invention discloses a highly sensitive wirelessly powered temperature monitoring microchip that accurately measures temperature of subject bodies including but not limited to pharmaceutical products such as vaccines, intravenous injections and other similar remedial medicines. The chip can be made with packaging, but it can also be made pad-less and package-less to cut costs, due to the wireless power transfer and backscattering data communication. In an embodiment, microchips are placed inside the vials, i.e., in direct contact with the temperature sensitive product, for example embedded in the interior bottom of the vial. Hence, they can directly measure the temperature and are powered wirelessly using Resonant Wireless Power Transfer (RWPT). The package-less microchips, with no pins, communicate by using the backscattering method and do not require batteries. There are two types of AC signals possible from RWPT coils, 180 degree and IQ signals. In the preferred embodiment, the temperature monitoring microchip uses IQ based AC logic circuits, such as those disclosed in co-pending U.S. patent Ser. No. 17/812,202 titled Ultra-Low Power Multi-Phase AC Logic Family. However, the temperature sensor in the present invention is novel when constructed using either IQ based AC logic or 180 degree-based AC logic. For AC operation, since there is no rectifier or regulator in the microchip and the resonant wireless power transfer's coupling can vary, the temperature monitoring microchip of the present invention uses a Band Gap Reference (BGR) oscillator and a feedback mechanism to accurately achieve a desired voltage amplitude in the microchip. The temperature measurement is made using a multitude of PTAT (Proportional to Absolute Temperature)/CTAT (Complementary to Absolute Temperature) oscillators. The BGR oscillator's output is sent to a main external microcontroller that controls the RWPT. The frequency of BGR oscillator is a strong function of the received wireless power but a weak function of temperature. The microcontroller uses it as a reference to achieve the desired voltage amplitude in the microchip. Furthermore, the microchips use ultra-low power which makes them feasible for battery operated portable containers. As a result, they can be mass produced at a very low cost and deployed efficiently and easily.

### BRIEF DESCRIPTION OF THE DRAWINGS

The accompanying drawings, which are incorporated in and constitute part of this specification, illustrate the embodiments of the invention and, together with the description, serve to explain the principles of the invention. The embodiments illustrated herein are presently preferred, it being understood by those skilled in the art, however, that the invention is not limited to the precise arrangements and instrumentalities shown, wherein:

FIG. 1 shows an architecture of a temperature sensing microchip that uses DC power.

FIG. 2 shows an architecture of a temperature sensing microchip that uses 180° AC power.

FIG. 3 shows an architecture of a temperature sensing microchip that uses quadrature AC power.

FIG. 4 shows a signal generation circuit that is used to prepare the data for backscattering; comprised of a ring oscillator, a clock divider, a parallel in/serial out shift register and a buffer.

FIG. 5 shows edge detection circuits that digitize the output of the temperature sensors and band gap reference oscillator to be sent to the signal generation circuit shown in FIG. 4.

FIG. 6 shows the ladder diagram depicting the procedure of supply amplitude locking between the temperature sensing microchip and external microcontroller unit.

FIG. 7 shows a temperature sensor designed using a 180° AC powered ring oscillator circuit and an inverter circuit.

FIG. 8 shows the output frequency versus temperature change of a ring oscillator circuit of an embodiment of FIG. 7.

FIG. 9 shows a temperature sensor designed using a quadrature AC powered ring oscillator and an inverter circuit.

FIG. 10 shows the output frequency with temperature variation of a ring oscillator circuit of an embodiment of FIG. 9.

FIG. 11 shows the frequency ratio of two-ring oscillator circuits, both based on FIG. 9, with different proportional to absolute temperature (PTAT) curves achieved by using different device sizes.

FIG. 12 shows a 180° AC powered ring oscillator based band gap reference (BGR) circuit and a corresponding single inverter.

FIG. 13 shows the output frequency of a band gap reference circuit with temperature and supply variations of an embodiment of FIG. 12.

FIG. 14 shows a quadrature AC powered ring oscillator based band gap reference (BGR) circuit.

FIG. 15 shows the output of a band gap reference circuit of an embodiment of FIG. 14.

FIG. 16 shows another embodiment of a quadrature AC powered temperature sensor, similar to that shown in FIG. 9, but using a parasitic BJT.

FIG. 17 shows the output of the quadrature AC powered based temperature sensor of an embodiment of FIG. 16.

FIG. 18 shows a flow diagram of an operating procedure of a temperature sensing microchip that uses AC power as described in the embodiments of FIG. 2 and FIG. 3.

FIG. 19 shows the binary data transmitted by a temperature sensing microchip with the error correction/detection and spreading codes.

FIG. 20 shows a 180° AC powered memory circuit.

FIG. 21 shows a quadrature AC powered memory circuit.

### DETAILED DESCRIPTION OF THE INVENTION

The figures and their corresponding embodiments provided in this disclosure are explained in detail for a thorough understanding of the invention and the accompanying embodiments. All such figures are schematic or block diagrams or preferred structures and they are not drawn to scale. Further, the schematics and block diagrams or structures are drawn to clarify the details of the invention. One skilled in the art can understand that only the core components are shown in the embodiments for a better enablement. Hence, any additional elements that would be included in these circuits or structures for implementation are implicitly understood to be a part of this disclosure. All embodiments, systems, structures, schematics, circuits, and subcircuits that utilize the fundamental principles of the invention or have elements of the invention are hereby treated to be under the complete protection of the disclosed invention.

The following terms are used in this disclosure: On-board Resonant Wireless Power Transferring and Backscattering data Receiving (PTBR) resonator; On-chip Resonant Wireless Power Receiving and Backscattering data Transferring (PRBT) resonator; On-board Resonant Wireless Power Transferring and Backscattering data Receiving (PTBR) inductor; On-chip Resonant Wireless Power Receiving and Backscattering data Transferring (PRBT) inductor; Proportional To Absolute Temperature (PTAT); and Complementary To Absolute Temperature (CTAT).

The disclosed concept provides a system and method that continuously monitors the temperature of individual vaccine bottles, preferably from within the glass vials, to segregate the effective ones from the ineffective or not so effective ones. The core of the system consists of a highly sensitive, pad-less, package-less, wirelessly powered temperature monitoring microchip that accurately measures temperature of subject bodies, including but not limited to pharmaceutical products such as vaccines, intravenous injections and other similar remedial medicines; and communicates it to a monitoring system. Further, the invention described herein can also be used for measuring the temperature of food products, blood samples, and any other sensitive products where the continuous monitoring of temperature is a mandatory or a regulatory requirement, or merely desired. The microchips may be placed preferably inside the vials, i.e., in a direct contact with the monitoring product. As a result, they can directly measure the temperature and are powered wirelessly using the Resonant Wireless Power Transfer (RWPT) technique. The package-less microchips having no pins, communicate temperature values by using the backscattering method, and do not require batteries or a power source. The microchips use AC logic-based operation. This makes the microchips ultra-low power. Therefore, they are suitable for placement in battery operated portable containers. Due to these promising features—pad-less, package-less, ultra-low power and wireless power transfer—they can not only be mass produced at a very low cost, but also be efficiently deployed in temperature monitoring systems.

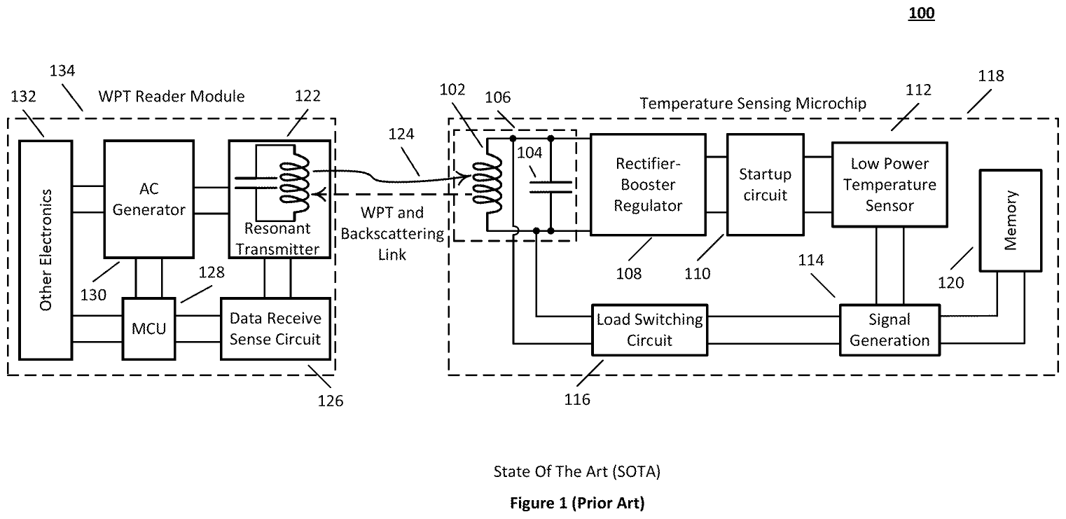

FIG. 1 shows the temperature sensing microchip 118 of a State-of-the-art (SOTA) DC powered embodiment of a temperature sensing microchip, similar to that disclosed in US20160313188, along with the WPT Reader Module 134 that requests data from the temperature sensing microchip 118. The WPT Reader Module 134 maybe an external chip or PCB based circuit. It may be powered through a battery, or from wall power, depending on the application scenario. The temperature sensing microchip 118 is powered wirelessly by the WPT Reader Module 134. The temperature sensing microchip 118 includes an On-chip Resonant Wireless Power Receiving and Backscattering Transferring (PRBT) circuit 106 comprised of On-chip Resonant Wireless Power Receiving and Backscattering Transferring (PRBT) inductor 102 and capacitor 104. It also includes rectifier-booster regulator 108, low power temperature sensor 112, load switching circuit 116, Startup circuit 110, permanently stored memory 120, and signal generation circuit 114. PRBT inductor 102 and capacitor 104 are used for resonant wireless power reception and data transfer using a backscattering technique through WPT and Backscattering Link 124. The wireless power is received from On-board Resonant Wireless Power Transferring and Backscattering data Receiving (PTBR) resonator 122 by on-chip PRBT resonator circuit 106 and is rectified to DC by rectifier-booster regulator 108 to power the chip. Temperature sensor 112 uses DC power to measure the temperature and transmits it to signal generator circuit 114. The temperature sensor's data, preferably along with data from memory circuit 120, is then sent to load switching circuit 116. Load switching circuit 116 changes the impedance of the load of on-chip PRBT resonator 106, which reflects it back at on-board PTBR resonator 122, in the WPT Reader Module 134, due to the backscattering effect, and it can be read once the load current changes. The change in the load current is measured by the data receive sense circuit 126 and then sent to the MCU (Microcontroller Unit) 128 which processes the data. MCU 128 also controls AC Generator 130 as well as other electronics 132 of the WPT Reader Module. The startup circuit 110 switches off the temperature sensor when the voltage is below a threshold, this prevents the sensor to operate below the rated voltages that may give erroneous temperature readings.

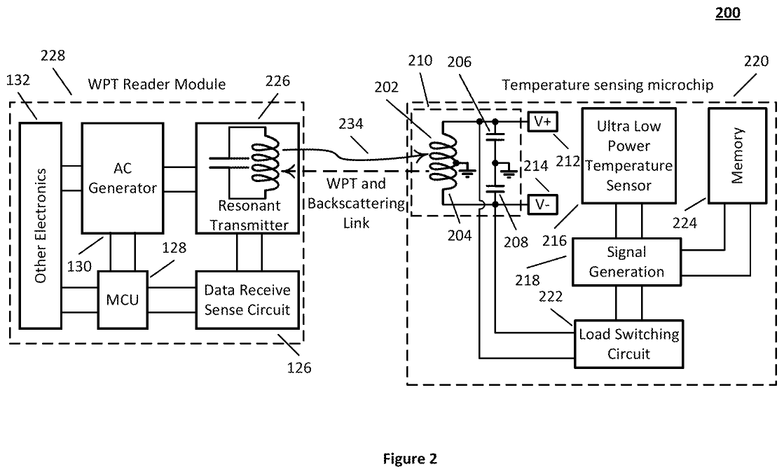

FIG. 2 shows a novel temperature sensing microchip 220, which directly uses the received 180° AC power without the need to rectify it to DC, as well as a WPT Reader Module 228 that requests data from the temperature sensing microchip 220. This embodiment enables ultra-low power operations. Since an AC to DC rectifier and regulator wastes a significant amount of power, especially in wirelessly powered systems, this embodiment eliminates the need for a DC rectifier. Consequently, the entire microchip operates directly on the received AC power using 180° AC logic. MCU 128 on WPT Reader Module 228 controls AC Generator 130 and the generated AC signals are transmitted using onboard PTBR circuit 226, as well as other electronics 132 and Data Receive and Sense Circuit 126. On-chip Resonant Wireless Power Receiving and Backscattering data Transferring (PRBT) resonator circuit 210, comprised of the inductors 202 and 204 and capacitors 206 and 208, receives the AC power transmitted by On-board Resonant Wireless Power Transferring and Backscattering data Receiving (PTBR) resonator circuit 226 through WPT and Backscattering Link 234, and generates the out of phase (180°) AC signals V+212 and V− 214 to power the microchip. Ultra-low power temperature sensor 216, signal generation circuit 218, load switching circuit 222, Memory Element 224, all operate on AC signals and AC power in this embodiment.

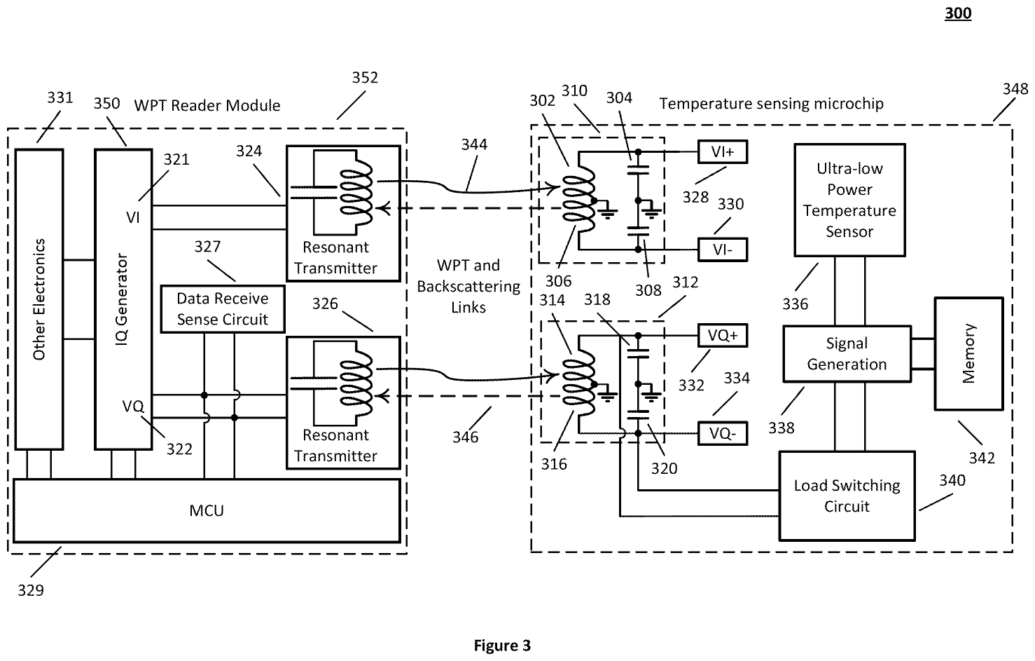

FIG. 3 shows the temperature sensing microchip 348 in an embodiment of the invention that directly uses the received AC power but with the IQ (quadrature) method. The MCU 329 of WPT Reader Module 352 controls IQ generator 350, to generate quadrature signal VI 321 and VQ 322, as well as controlling other electronics 331. The two different On-chip Resonant Wireless Power Receiving and Backscattering data Transferring (PRBT) resonator circuits, circuit 310 comprised of the inductors 302 and 306 and capacitors 304 and 308 and PRBT resonator circuit 312 comprised of inductors 314 and 316 and capacitors 318 and 320, receive quadrature AC signals VI 321 and VQ 322, that are transmitted by On-board Resonant Wireless Power Transferring and Backscattering data Receiving (PTBR) resonator circuits 324 and 326, through WPT and Backscattering Links 344 and 346 respectively. The two different signals are received by PRBT resonator 310 and PRBT resonator 312 to generate signals VI+ 328, VI− 330, VQ+ 332 and VQ− 334 inside the microchip, which power the microchip. Ultra-low power temperature sensor 336, signal generation circuit 338, load switching circuit 340, memory element 342 operate on these signals and hence the entire chip operates on the AC IQ logic.

In another embodiment of the invention, data receive sense circuit 327 can be replaced by a version that can be connected to both phases VI and VQ to receive the backscattered data on both of them.

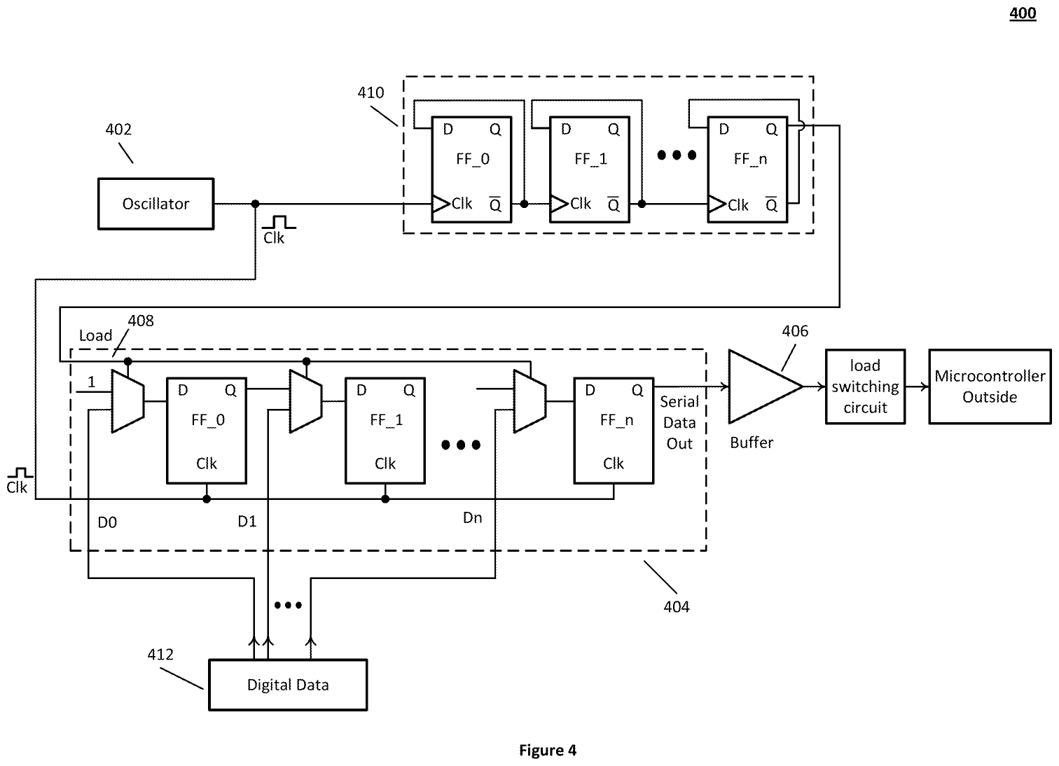

FIG. 4 shows the signal generation circuit of a quadrature AC temperature sensing microchip, for instance signal generation circuit 338 of temperature sensing microchip 348, comprised of parallel in/serial out shift register 404 of the size determined by the total number of required bits, clock generator or oscillator circuit 402, and frequency divider circuit 410. The circuit can also include buffer 406 if needed. The digital data 412 including the data from the AC ultra-low power temperature sensor 336, the chip ID, and any other desired data from memory circuit 342 is loaded into register 404. The rate at which this data is transmitted is determined by the clock generated by clock generator or oscillator circuit 402. Load signal 408 controls the frequency at which the temperature values are updated in register 404 and is generated using clock divider 410 after oscillator circuit 402. In another embodiment, load signal 408 can be implemented as a separate oscillator with a similar circuit to 402 but with a lower frequency, or it can instead be generated using other circuit as would be known to one skilled in the art.

In the preferred embodiment of FIG. 3, the circuit shown in FIG. 4 may be implemented using quadrature AC logic gates that are disclosed in the co-pending U.S. patent application Ser. No. 17/812,202, incorporated herein by reference. In the embodiment of FIG. 2, the circuit shown in FIG. 4 may be implemented using 180° AC logic gates that are also disclosed in the co-pending U.S. patent application Ser. No. 17/812,202. In an embodiment using 180° AC logic, the digital data 412 would also be generated by 180° AC powered counterparts. The circuit's operating principle and logic configuration remains the same but the quadrature AC logic gates and Flip Flops are replaced by their 180° AC powered counterparts.

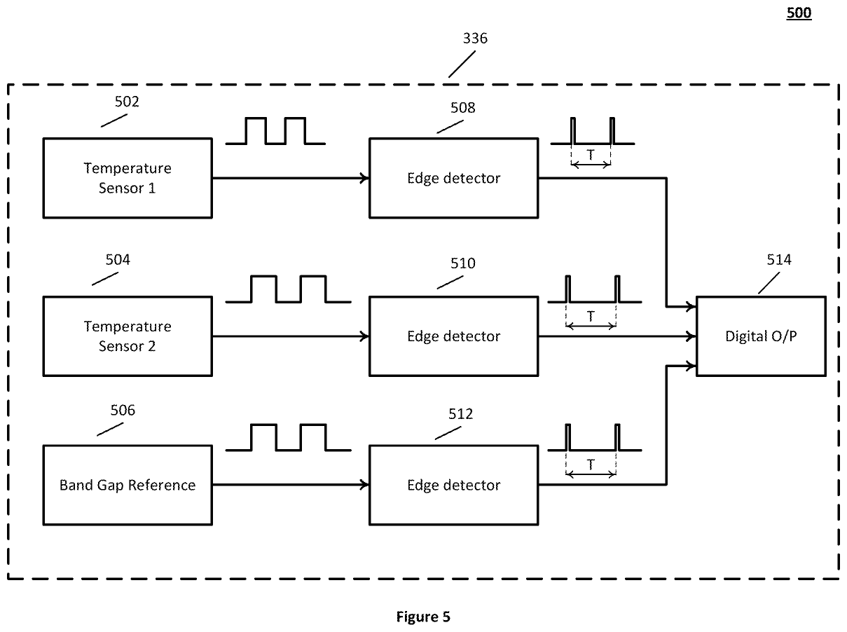

FIG. 5 shows the block diagram of a novel quadrature AC powered ultra-low power temperature sensor 336 used in the embodiment of the temperature sensing microchip 348 shown in FIG. 3. A similar 180° temperature sensor may be constructed for the embodiment shown in FIG. 2. One of the main challenges of WPT, especially when the voltages received in the microchip are not rectified and regulated, is the power supply variation. Since the microchip is powered using RWPT from outside, the amplitude of the AC voltages that appear on VI+ 328, VI− 330, and VQ+ 332 depend on the coupling established between PTBR resonator circuit 324 and PRBT resonator circuit 310 and the coupling established between PTBR resonator circuit 326 and PRBT resonator circuit 312. However, this coupling is subject to material properties, distance and misalignment between the two inductors. Therefore, the power supply amplitude may significantly vary. This issue is resolved by using Band Gap Reference (BGR) Oscillator 506 to establish a feedback mechanism with MCU 329 of the WPT Reader Module 352 with which it is communicating. The oscillation frequency of BGR Oscillator 506 is independent of the temperature at a nominal supply amplitude. Furthermore, at voltages below this nominal value, the frequency of BGR Oscillator 506 is lower than the nominal frequency throughout the desired temperature range, and consequently it is higher at voltages that are greater than this nominal value. Thus, the output frequency of BGR oscillator 506 establishes a reference for the received power supply strength inside the temperature sensing microchip. MCU 329 starts by sending a weak signal to PTBR resonators 324 and 326 and these turn on the temperature sensing microchip 348. The temperature sensing microchip 348 then sends the output frequency of BGR oscillator 506 to MCU 329 by using backscattering method. MCU 329 measures the received frequency and compares it to the expected value within a predetermined margin of error. If the received frequency is lower than the expected, MCU 329 increases the voltages at PTBR resonators 324 and 326 respectively, which in turn increases the voltages received at PRBT resonators 310 and 312, as the coupling is constant in each fixed setup. This causes the frequency of BGR oscillator 506 to increase until it reaches its nominal value. At this point, the microcontroller stops increasing the voltages at 324 and 326, and that establishes a reasonable lock. If at any point, the received frequency is higher than the expected, due to changes in the physical distance between PTBR resonators 324 and 326 and PRBT resonators 310 and 312, the microcontroller reduces the voltages. In an embodiment, MCU 329 may store the chosen voltages as nominal voltages to start the process from a point closer to the voltages required the next time this process occurs. ‘Temperature Sensor 1’ 502 and ‘Temperature Sensor 2’ 504 are designed to have different characteristics at the nominal amplitude voltage. In a preferred embodiment, the two temperature sensors are based on ring oscillators with PTAT characteristics, i.e., their frequencies increase with an increase in temperature. However, one of the two temperature sensors, 502 and 504, is designed to have a stronger PTAT behavior than the other which can be achieved by slightly changing their device sizes or by using different number of inverters. As a result, the ratio of their frequencies is a strong CTAT function which can be used by MCU 329 to determine the exact temperature. Using two temperature sensors, instead of just one, reduces the supply sensitivity as the ratio of their frequencies is a much stronger function of temperature than of the power supply. This relaxes the design constraints of BGR Oscillator 506 and also allows more room for process variations. The frequencies of oscillators are measured by calculating the time difference between their edges. The edge detector circuits 508, 510 and 512 are used to find the edges of the output signals of ring oscillator-based temperature sensors 502 and 504, and BGR oscillator 506, respectively. These edges are used as binary data, i.e., 0 in the absence of an edge and 1 in the presence of an edge and this digital output 514 is transmitted to MCU 329 outside the chip using the backscattering method. MCU 329 measures the time interval between two consecutive Is to determine the oscillating frequency. In a preferred embodiment of the invention, BGR Oscillator circuit 506 only needs to be powered on at the startup to establish the desired voltages. After a short period of time, it can be turned off to save power.

In another embodiment of the invention, one of the temperature sensors 502 and 504 has a PTAT behavior and the other one has a CTAT behavior. Similarly, two CTAT temperature sensors can also be used in yet another embodiment.

In another embodiment of the invention, if BGR Oscillator circuit 506 and the feedback mechanism is accurate enough, only one temperature sensor 502 is used and 504 is not required.

In another embodiment of the invention, the methodology shown in FIG. 5 for ultra-low power temperature sensor 336, based on the quadrature IQ logic, can also be used with 180° AC based ultra-low power temperature sensor 216.

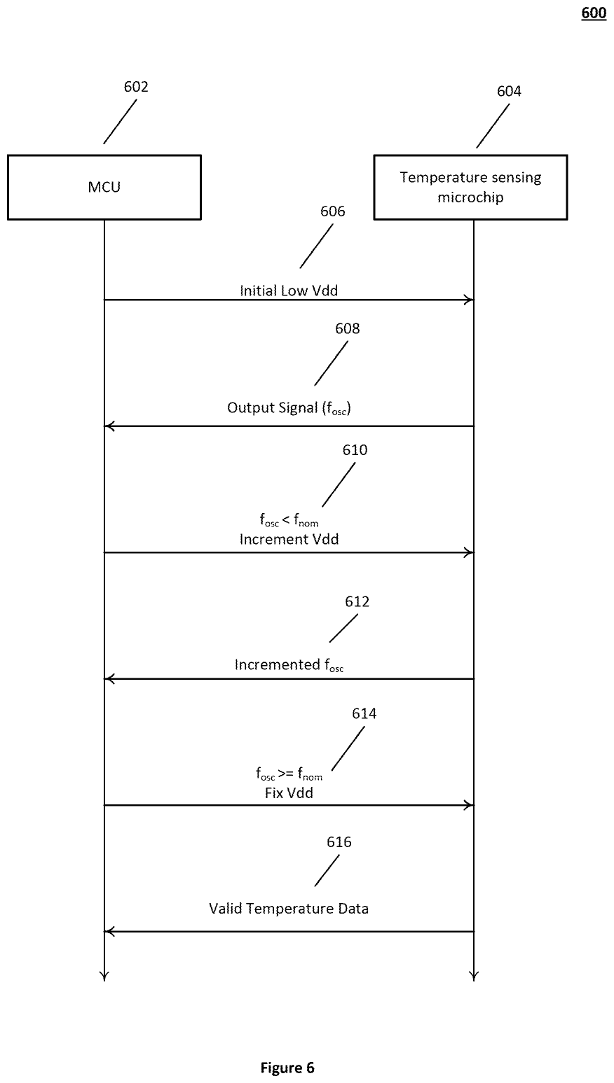

FIG. 6 shows the ladder diagram explaining communication protocol between External Microcontroller Unit (MCU) 602, which maps to 329, and the temperature sensing microchip 604, which maps to 348. The MCU 602 powers 604 through low initial voltage 606 and records the resulting frequency (f_{osc}) 608. If the f_{osc} is lower than the nominal frequency, the MCU increases the input voltage until oscillating frequency is greater than or equal to the nominal frequency as shown in 610 and 612. After the frequency of the Temperature sensor 604 reaches a nominal value, the MCU 602 locks the VDD 614 and starts to take valid temperature data 616 from the Temperature Sensor 604.

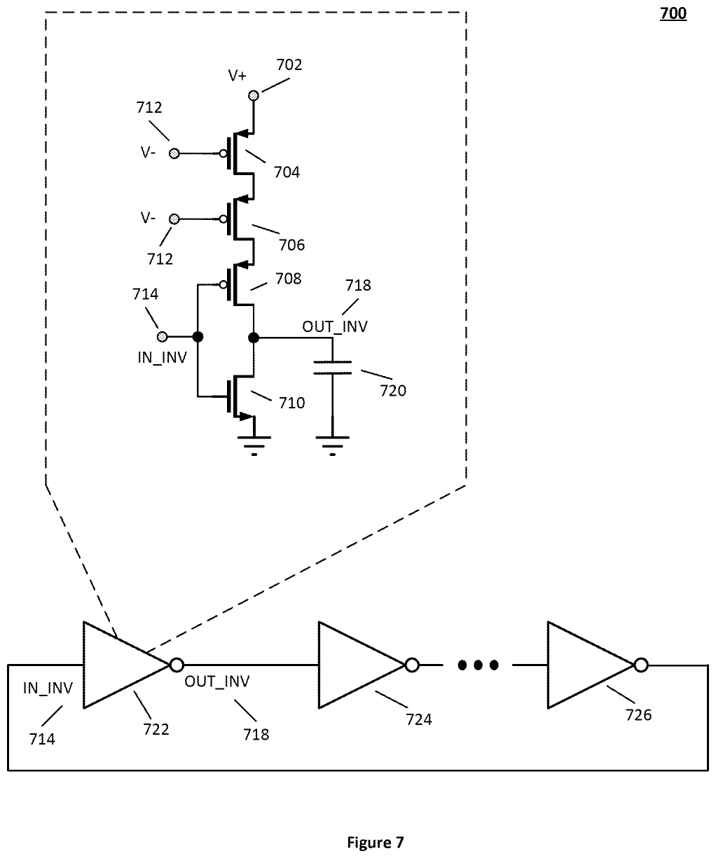

FIG. 7 shows an AC powered ring oscillator circuit for an embodiment of FIG. 2. The circuit uses 180° out of phase AC signals V+ 702 and V− 712 and is based on a 180° AC logic inverter circuit disclosed in the co-pending U.S. patent application Ser. No. 17/812,202, wherein output OUT_INV 718 of each inverter is connected directly to input of the next inverter. The input IN_INV 714 is applied to the transistor 708 and 710 to get inverted output OUT_INV 718. It has an odd number of inverters 722, 724 and 726, and the output frequency can be controlled by changing the number of inverters, or by changing capacitance 720, or the size of the devices 704, 706, 708, or 710. The frequency of ring oscillator 700 is a strong function of the temperature which makes it a good temperature sensor. The signals V+ 702, and V− 712, map to V+ 212, and V− 214 of FIG. 2.

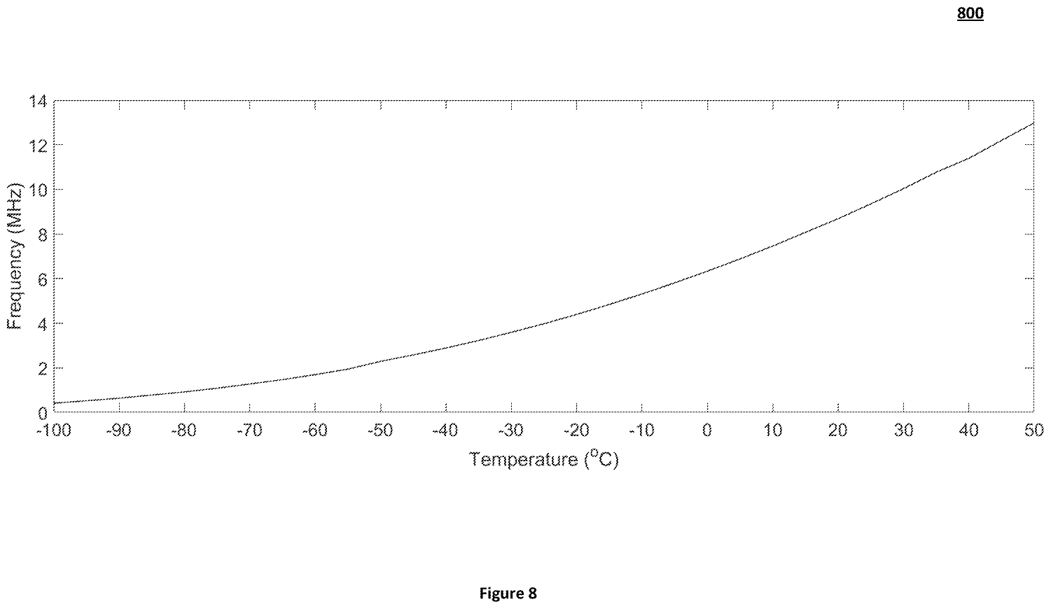

FIG. 8 shows the output frequency of ring oscillator circuit 700 of an embodiment of FIG. 7 as the sensed ambient temperature varies.

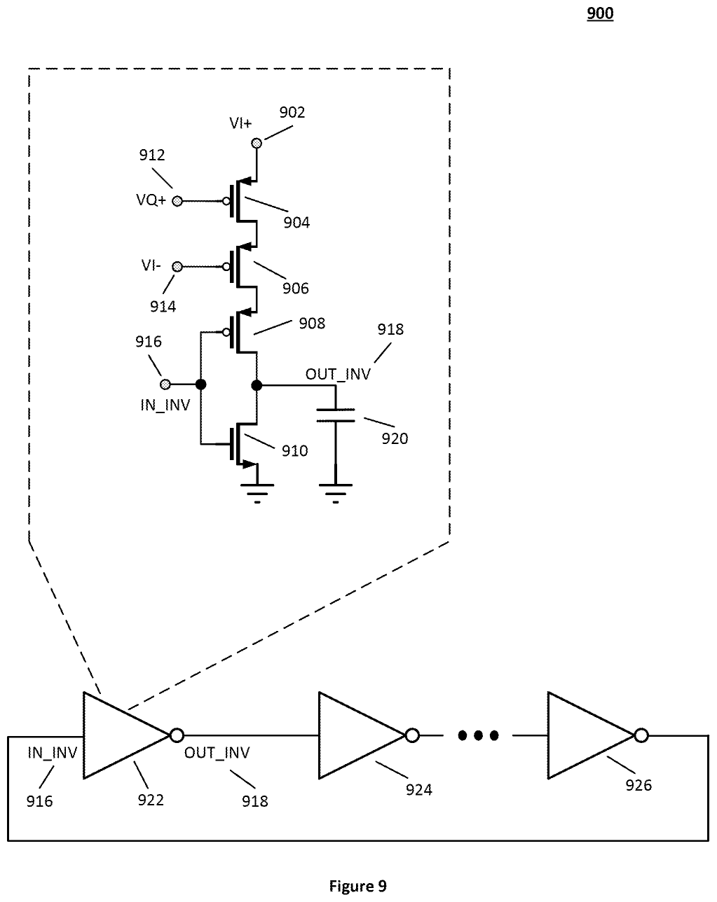

FIG. 9 shows quadrature AC powered ring oscillator circuit that may be used in an embodiment of FIG. 3. The circuit uses quadrature signals VI+ 902, VQ+ 912, and VI− 914, and is based on a quadrature AC logic inverter circuit filed in the co-pending U.S. patent application Ser. No. 17/812,202. Output OUT_INV 918 of each inverter, 922, 924, and 926 is connected directly to input IN_INV 916 of the next inverter and the output frequency can be controlled by changing the number of inverters, or by changing capacitance 920, or the sizes of the MOSFETs 904, 906, 908, or 910. The signals VI+ 902, VQ+ 912, and VI− 914, map to VI+ 328, VQ+ 332, and VI− 330 of FIG. 3.

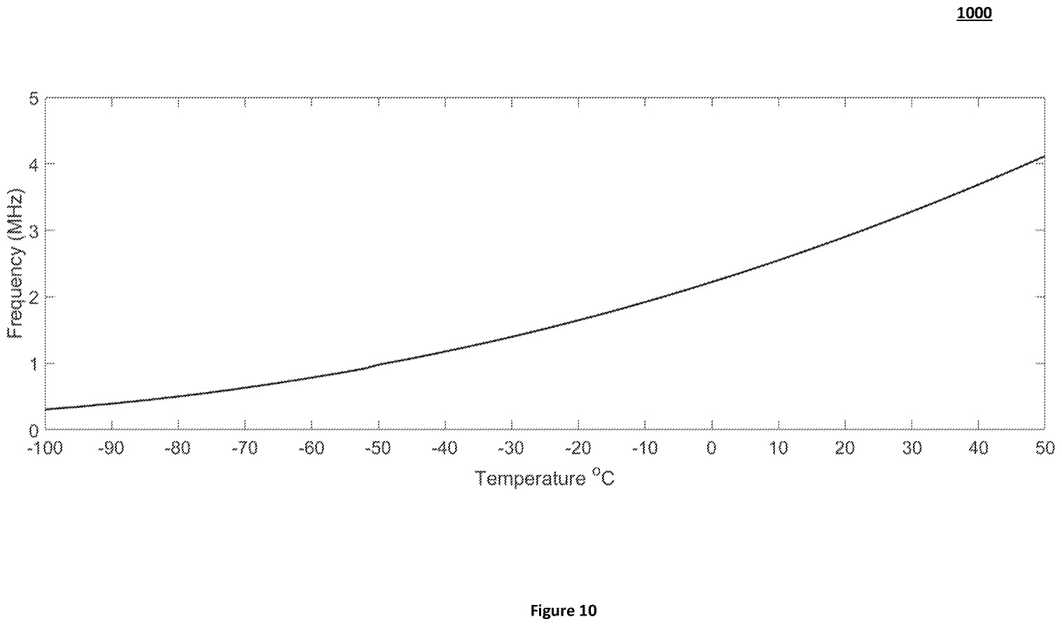

FIG. 10 shows the output frequency of ring oscillator circuit 900 of an embodiment of FIG. 9 as the sensing ambient temperature varies.

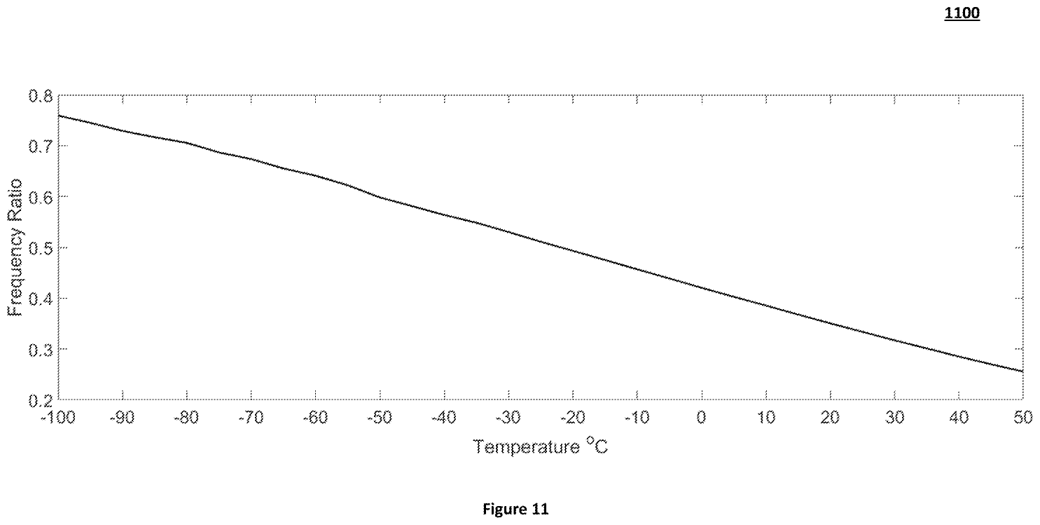

FIG. 11 shows the ratio of frequencies of two ring oscillators as the sensed ambient temperature varies.

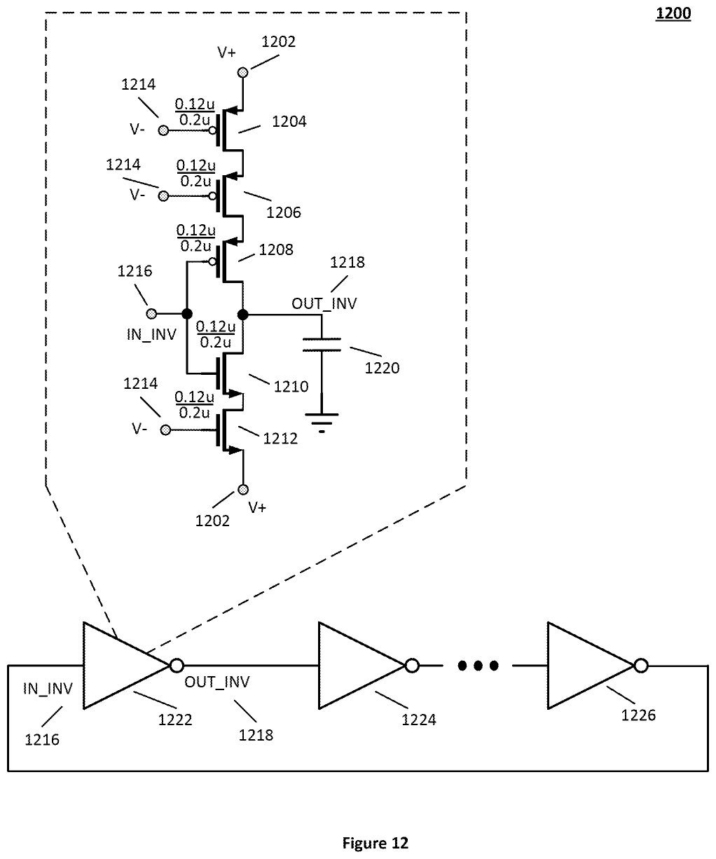

FIG. 12 shows AC powered (180°) ring oscillator-based band gap reference (BGR) circuit, wherein output OUT_INV 1218 of each inverter is connected directly to input IN_INV 1216 of the next inverter. The circuit is similar to that of 700 of FIG. 7, except that the transistors have a large channel length, an additional transistor 1212 that is controlled by signal V− 1214 is added in the discharging branch, and the ground is replaced by voltage V+ 1202. Replacing the ground with voltage V+ 1202 changes the circuit to its adiabatic topology, and a longer channel length reduces the threshold voltage (Vth) and makes it possible for the oscillator to achieve the desired BGR characteristics at the same voltage supply at which oscillator circuit 700 behaves as PTAT. The frequency of BGR oscillator 1200 is independent of the sensed temperature at the nominal RMS voltage of V+ 1202. At voltages lower than the expected, the output frequency remains significantly lower than the nominal frequency which makes the detection of nominal supply voltage inside the chip easy. The nominal frequency of BGR oscillator can be controlled by changing the number of inverters (1222, 1224 and 1226), or by changing capacitance 1220, or the size of devices 1204, 1206, 1208, 1210 or 1212. The signals V+ 1202, and V− 1214, map to V+ 212, and V− 214 of FIG. 2.

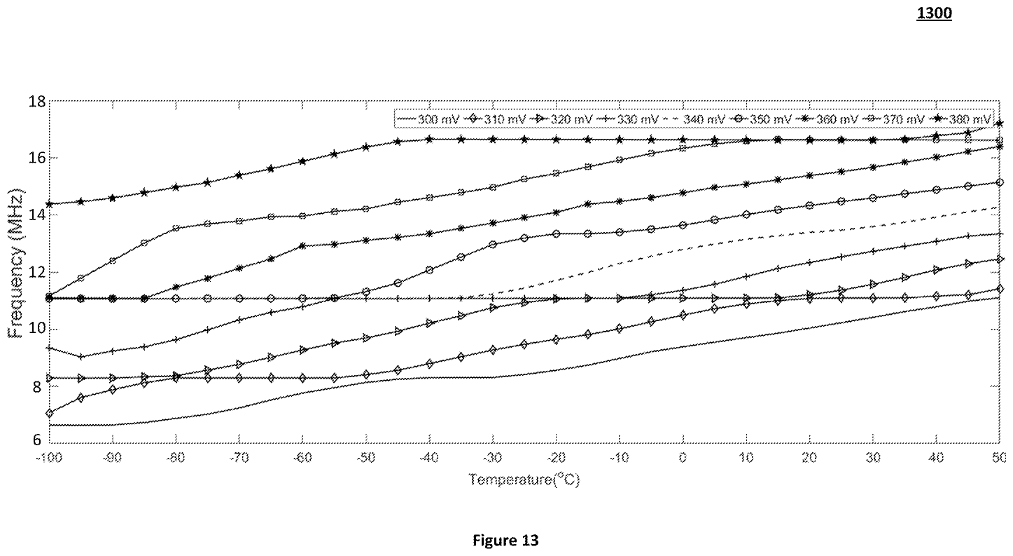

FIG. 13 shows the output frequency of ring oscillator circuit 1200 shown in FIG. 12, as the sensed temperature varies when the amplitude of different supply voltage is also changed. The amplitude of voltage varies in the range 300 mV to 370 mV, generate the desired frequency at some temperature values, whereas the amplitudes that are outside this range generate different frequencies. Thus, if an external MCU locks on to this frequency of 11 MHz, the amplitude of supply voltage in the microchip can be expected to be somewhere in the range between 310 mV and 370 mV.

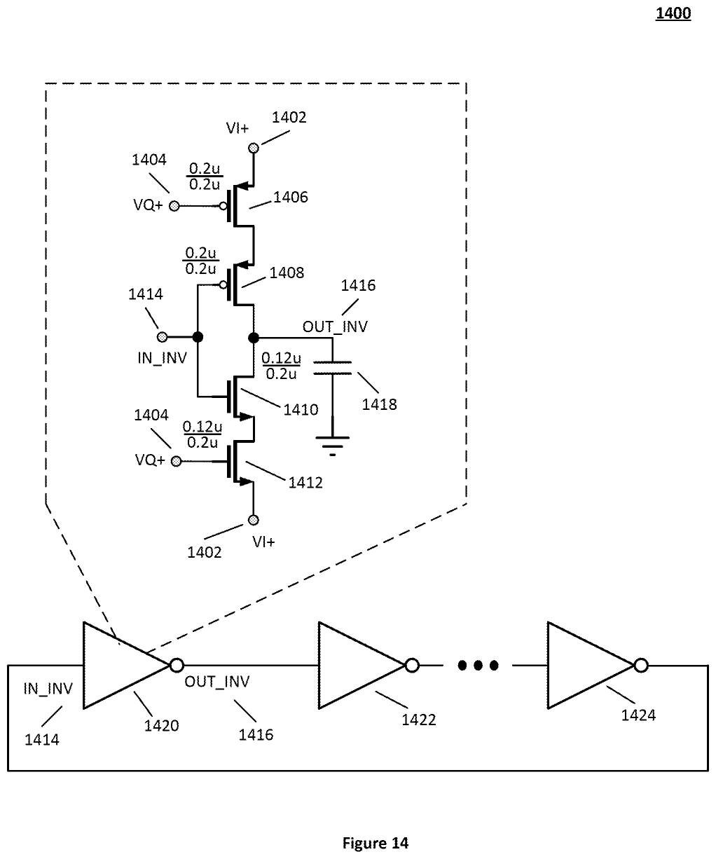

FIG. 14 shows the quadrature AC powered ring oscillator-based BGR circuit 1400, wherein output OUT_INV 1416 of each inverter is connected directly to input IN_INV 1414 of the next inverter. The circuit is like 900 of FIG. 9 except that the transistors have a large channel length, an additional transistor 1412 that is controlled by signal VQ+ 1404 is added in the pull-down path, an isolation transistor 906 from the pull up path is removed, and the ground is replaced by voltage VI+ 1402. This reduces Vth and makes it possible for the oscillator to achieve desired BGR characteristics at the same supply voltages at which oscillator circuit 900 behaves as PTAT. The frequency of BGR oscillator 1400 is independent of the temperature at the nominal RMS voltage of VI+ 1402. The output frequency at lower supply voltages remains significantly lower than the nominal frequency, which makes it easier to detect the nominal supply voltage inside the chip. The nominal frequency of BGR oscillator 1400 can be controlled by changing the number of inverters (1420, 1422 and 1424), or by changing the capacitance 1418, or the sizes of devices 1406, 1408, 1410 or 1412. The signals VI+ 1402, VQ+ 1404 map to VI+ 328, VQ+ 332 of FIG. 3.

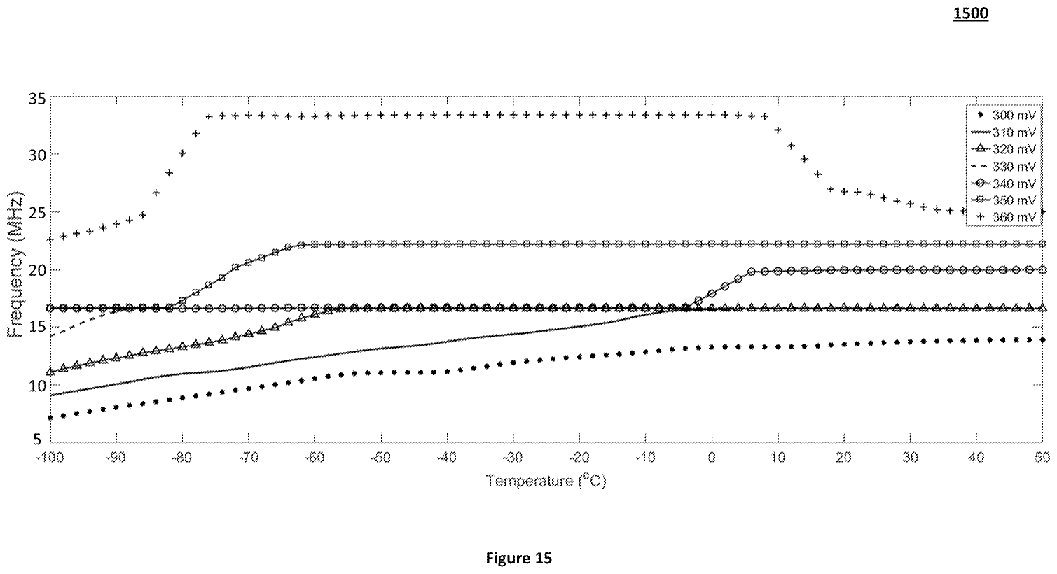

FIG. 15 shows the output frequency of the ring oscillator based BGR circuit 1400, as the sensed temperature varies when the amplitude of different supply voltage is also changed. The voltage amplitudes vary in the range 310 mV to 350 mV, generate the desired frequency at some temperature values, whereas the amplitudes outside this range generate different frequencies. Thus, if an external MCU locks on to this frequency of 16 MHz, the amplitude of supply voltage in the microchip can be anywhere in the range between 310 mV to 350 mV.

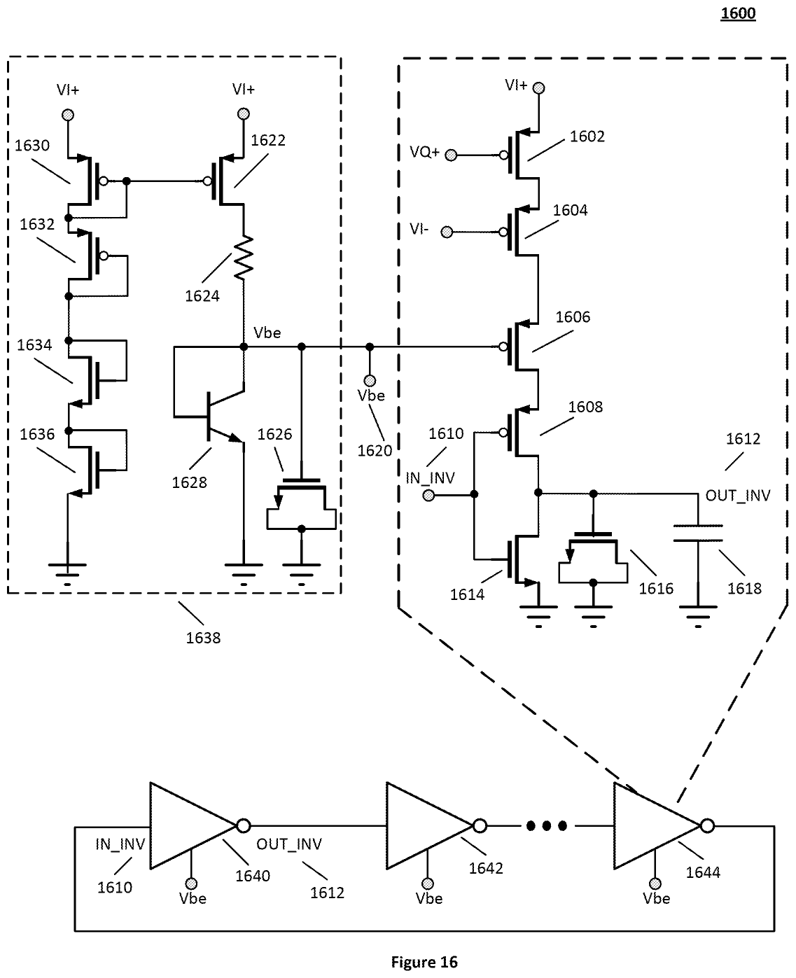

FIG. 16 shows an alternate embodiment of a quadrature AC powered ring oscillator-based temperature similar to sensor 900 shown in FIG. 9 but with additional BJT based control circuit 1638 that controls the gate signal of transistor 1606. Similar to the previous embodiments, output OUT_INV 1612 of each inverter, 1640, 1642 and 1644, is connected directly to input IN_INV 1610 of the next inverter. BJT 1628 is charged through transistor 1622 and resistor 1624 to a voltage Vbe 1620 that is a function of both supply voltage and the current temperature. Transistors 1630, 1632, 1634, and 1636 are used to establish a gate voltage at transistor 1622 being a part of a pseudo current mirror. Use of four transistors is not necessary and only two of them will suffice if lower path resistance is desired. Transistors 1616 and 1626 are used as capacitors, but they can also be replaced with other capacitors similar to 1618. The transistor 1602 and 1604 powers the circuit using AC signals while the transistor 1608 and 1614 are used as inverter in the circuit. As compared to circuit 900 of FIG. 9, the frequency variation of this circuit is more linear both with a change in temperature and supply voltages which can further improve the accuracy of measuring temperature, but at the expense of additional power consumption due to more transistors.

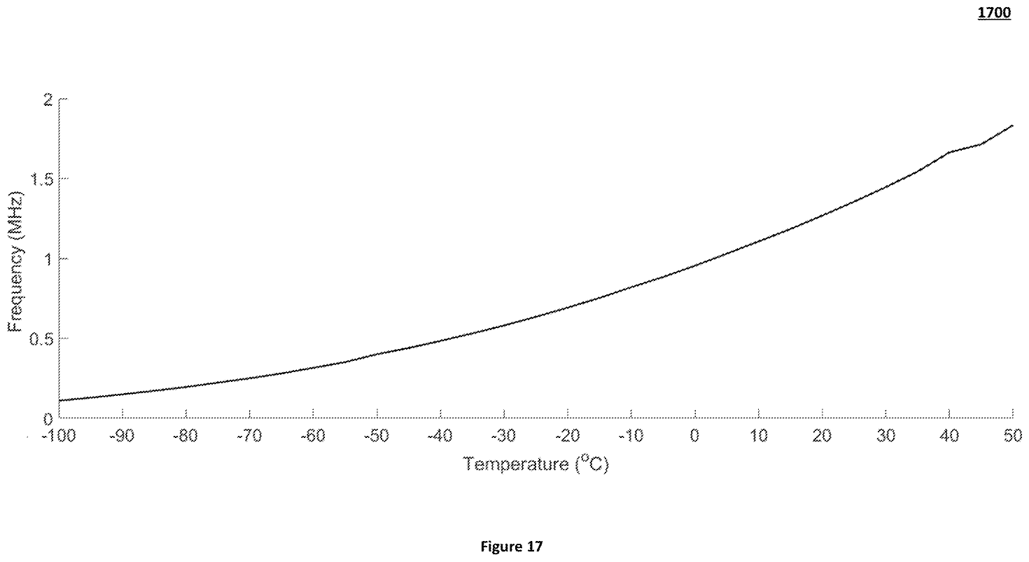

FIG. 17 shows the output frequency of ring oscillator circuit 1600 with respect to the change in the temperature.

In the invention, the frequency of the temperature sensor is used to measure the temperature. This frequency must also be communicated to the circuits outside the block, along with the chip ID and other data using the backscattering link. In some embodiments of the invention, the generated signal is directly used to control the impedance of the backscattering switch, which generates an amplitude modulated current signal in the resonant transmitter outside the chip. Edge detection circuits 508, 510, and 512 are not used in temperature sensor 500 in this embodiment. This signal can then be passed through an envelope detector that resides outside the chip, i.e., in the WPT Reader Module 352 to get the oscillator generated output, and then compute the frequency using this signal. In this embodiment, the oscillator generated signal and the data from on-chip Memory 342 can also be alternatively sent by using in time division multiplexing.

In an embodiment of the invention, the temperature sensor microchip includes edge detection circuits 508, 510 and 512 that generate a high pulse (1) only at the positive edge or zero crossing of the signal. For the rest of the duration, the output of this circuit is low (0). Thus the time difference between two consecutive pulses of this signal will be the time difference between two consecutive edges of the generated signal of a temperature sensor. Edge detection circuits 508, 510, and 512 can be implemented by using the quadrature AC XOR gate circuit disclosed in co-pending U.S. patent application Ser. No. 17/812,202. By including the output of this circuit directly in the digital sequence, which is to be transmitted using ASK backscattering, the temperature sensing microchip can send the edges of a generated signal to the outside world. The microcontroller residing outside the chip can then measure the precise time difference between two consecutive pulses to calculate the frequency of the signal and use that to compute the temperature. The edge detection circuit proposed in this embodiment can be implemented by using a quadrature AC powered XOR gate that is disclosed in the co-pending U.S. patent application Ser. No. 17/812,202. For this purpose, two consecutive outputs of the same temperature sensor oscillator circuit can be directly connected to the XOR gate to get an edge detector circuit, as known to the ones skilled in the art, as the two outputs would only be same at the two edges of the signal. Similarly other methods of edge detection can also be used.

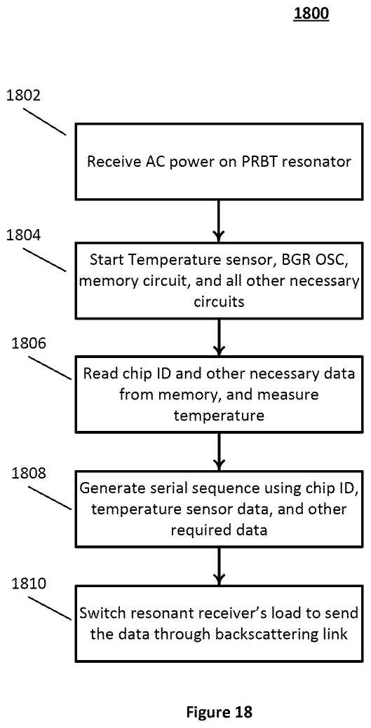

FIG. 18 describes the method that is used by an embodiment of the temperature sensing microchip. The chip receives the resonant wireless power from PRBT(s) from outside the microchip in step 1802. Then the main components of the chip, including the temperature sensor, the BGR, the memory circuit, etc., are all powered up in step 1804, and the temperature reading operation begins. Once the temperature data, chip ID, and other essential parameters are available, this data is read in step 1806 and a sequence is generated in step 1808. The sequence is then sent to a load switching circuit and transmitted through the backscattering link in step 1810.

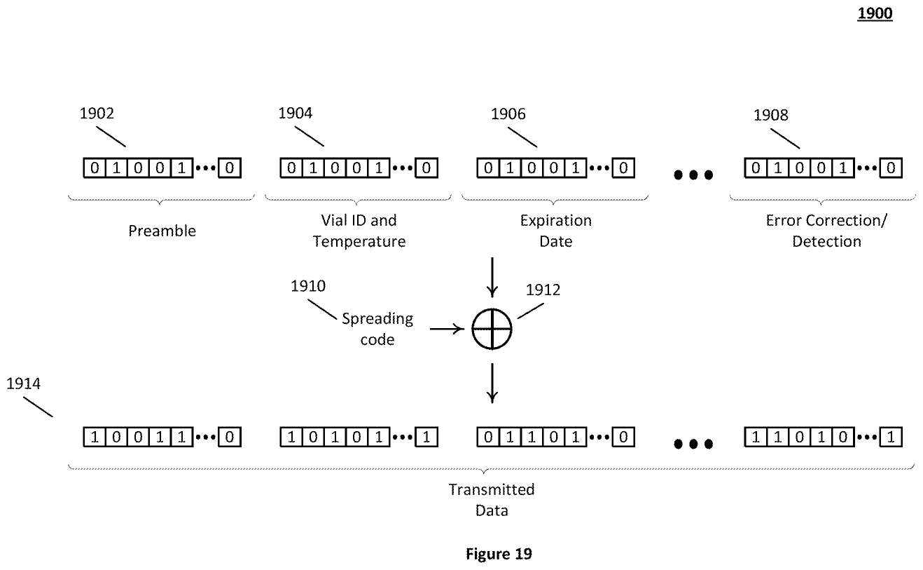

FIG. 19 shows the preferred embodiment of how the data is sent from a temperature sensing microchip in a vial to on-board PTBR(s) through a backscattering link. Since the vial ID and the temperature data would cover a range of digital values, sequences with a large number of consecutive zeros or consecutive ones may occur. However, such a long stream can be interpreted by a microcontroller as an error during the communication. Therefore, it is preferable that the transmitted data be continuously changing to avoid such misinterpretations by using techniques such as a spreading code. Further, a checksum or similar error detection code or error correction code may be used to ensure the data integrity. Codes such as hamming codes, repetition codes, multidimensional parity codes, checksum, cyclic redundancy check, etc., or other codes known to the ones skilled in the art can be used for error correction/detection. As shown in FIG. 19, a microchip sends preamble 1902, vial ID and temperature data 1904, expiry date 1906, and any other data, such as manufacturer and lot number, after applying error correction/detection code 1908, and after taking its XOR 1912 with a predetermined spreading code 1910 for avoiding long runs of consecutive zeros or consecutive ones. Transmitted data 1914 is then sent through the backscattering link after which an MCU uses the same spreading code to recover the received data. The spreading code used may be fixed which would allow it to be universal and is used for avoiding long consecutive streams of constant patterns. The sequence of data shown in FIG. 19 is not limited to this depiction only and any other data sequence of any other length can also be used. Similarly, the frequency of temperature checking for each vial is not fixed and can also be changed. Furthermore, the preamble and data such as vial ID, expiry date, etc., is preferably set once for every temperature sensing microchip and will remain unchanged during the normal operation, whereas the temperature data and error correction/detection code will vary according to the ambient conditions. In another embodiment, some of the data can also be sent directly without using the error correction code. While the temperature sensing microchip is described in the context of being in a medicine vial, one skilled in the art would understand its applicability to other temperature sensing applications and the required modification and composition of stored data such as vial ID.

In another embodiment of the invention microcontroller unit 329 can send different signal amplitudes, or power levels, to the temperature sensing microchip via RWPT. Once a nominal voltage amplitude is achieved inside the microchip, using the output frequency of the band gap reference oscillator circuit, as explained in an embodiment of FIG. 6, microcontroller unit 329 registers it as the nominal voltage. The temperature sensing microchip, when receiving this voltage, sends all of its data using the method described in FIG. 19 including the vial ID, expiry date, etc., as well as the data of temperature sensor. If Microcontroller Unit 329 requires some other arrangements of data, be it less or more than the quantum, it may increase the amplitude of the voltage. Thus, if a temperature sensing microchip senses higher voltage amplitudes than the nominal values, it sends a different set of data. Similarly, it may send a third set of data in case the received voltage amplitude is lower than the expected nominal value. This approach, of using the power level or voltage amplitude of RWPT is one way to communicate information from microcontroller unit 329 to temperature sensing microchip. In this way, a limited on-demand bidirectional communication mechanism is established.

The chip ID can be read from EEPROM or flash memory, or any other type of memory. Since we only need read from it and not write to it, the chip can operate normally at lower power values as well.

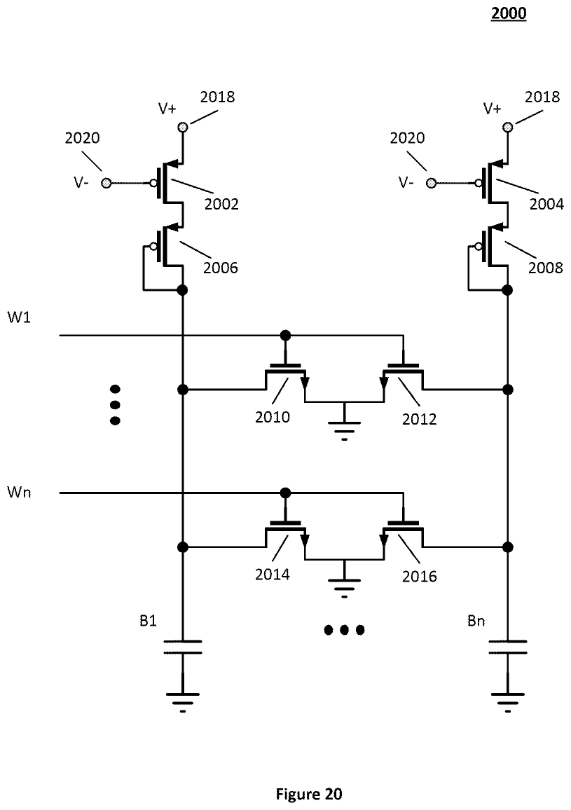

FIG. 20 shows an embodiment of an 180° AC powered permanent memory for an embodiment shown in FIG. 2. The circuit works on the same principle of a NOR configuration of a conventional memory circuit with certain modifications for supporting the configuration powered by AC signals V+ 2018 and V− 2020. PMOS transistors 2002 and 2004 are used to charge the bit lines and transistors 2006 and 2008 are used for providing isolation. NMOS transistors 2010, 2012, 2014, and 2016 are used as memory elements. The memory, as in the conventional memory circuits, can be programmed using any method of threshold voltage variation such as using different types of transistors, or using FGMOS (Floating Gate MOSFET), etc., which can be programmed during the manufacturing process of a microchip. The signals V+ 2018, and V− 2020, map to V+ 212, and V− 214 of FIG. 2.

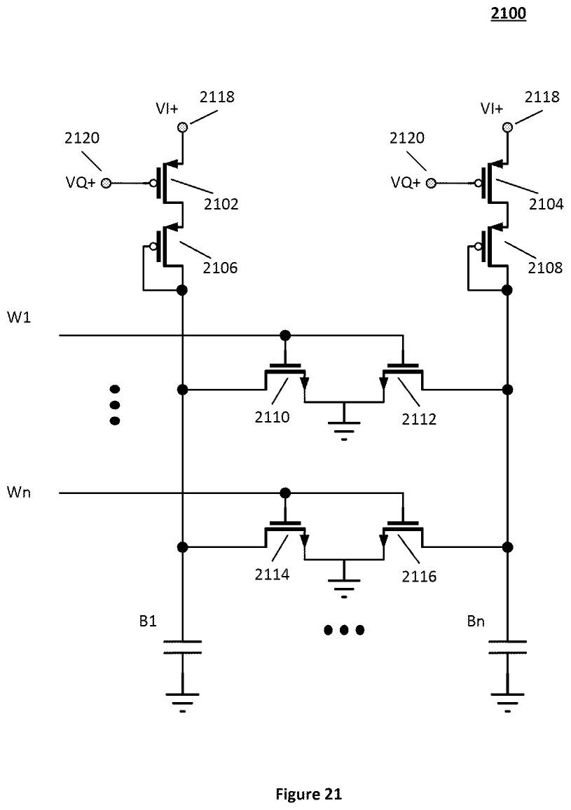

FIG. 21 shows an embodiment of a quadrature AC powered permanent memory. The circuit works on the same principle of a NOR configuration of a conventional memory circuit with certain modifications for supporting the configuration powered by quadrature AC signals. PMOS transistors 2102 and 2104 are used to charge the bit lines and transistors 2106 and 2108 are used for providing isolation. NMOS transistors 2110, 2112, 2114, and 2116 are used as memory elements. The primary difference between the embodiment of FIG. 20 and FIG. 21 is the phases between the power signal VI+ 2118 and gating signal VQ+ 2120 of the PMOS transistors in the pull up network. The memory, as in the prior art, can be programmed using any method of threshold voltage variation, such as using different types of transistors, or using FGMOS (Floating Gate MOSFET), etc., which can be programmed during manufacturing process of a microchip. The signals VI+ 2118, VQ+ 2120 map to VI+ 328, VQ+ 332 of FIG. 3.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A wirelessly powered temperature sensing microchip, comprising:
a number of power receiving and backscattering data transferring (PRBT) receivers for receiving a number of first AC signals from a reader module and for generating a number of second AC signals from the number of first AC signals;
a temperature sensor for measuring a temperature of the temperature sensing microchip;
a signal generation circuit coupled to the temperature sensor for generating a signal indicative of the measured temperature; and
a load switching circuit coupled to the signal generation circuit for receiving the signal indicative of the measured temperature and for providing backscattering, wherein the temperature sensor, the signal generation circuit, and the load switching circuit operate on and are powered by the number of second AC signals.

2. The temperature sensing microchip according to claim 1, wherein the temperature sensing microchip is package-less and pad-less.

3. The temperature sensing microchip of according to claim 1, wherein the temperature sensing microchip does not need AC to DC conversion or rectification to operate.

4. The temperature sensing microchip according to claim 1, wherein the number of first AC signals is each a 180 degree AC signal, and wherein the temperature sensor employs 180 degree-based AC logic.

5. The temperature sensing microchip according to claim 4, wherein the number of first AC signals is a single 180 degree AC signal, wherein the number of PRBT receivers is a single PRBT receiver that is structured and configured to generate the number of second AC signals, and wherein the number of second AC signals comprises two out of phase 180 degree AC signals V+ and V−.

6. The temperature sensing microchip according to claim 1, wherein the number of first AC signals is each an IQ quadrature AC signal, and wherein the temperature sensor employs IQ-based AC logic.

7. The temperature sensing microchip according to claim 6, wherein the number of first AC signals is a first IQ quadrature AC signal and second IQ quadrature AC signal, wherein the number of PRBT receivers comprises a first PRBT receiver that is structured and configured to receive the first IQ quadrature AC signal and a second PRBT receiver that is structured and configured to receive second IQ quadrature AC signal, and wherein the number of second AC signals comprises four IQ quadrature AC signal VI+, VI−, VQ+ and VQ−.

8. The temperature sensing microchip according to claim 6, wherein the temperature sensor includes a band gap reference (BGR) oscillator and employs a feedback mechanism to accurately achieve a desired voltage amplitude in the temperature sensing microchip.

9. The temperature sensing microchip according to claim 8, wherein the feedback mechanism uses a microcontroller outside of the temperature sensing microchip.

10. A temperature sensing method, comprising:
receiving a number of first AC signals in a microchip;
generating a number of second AC signals from the number of first AC signals in the microchip;
measuring a temperature in the microchip;
generating a signal indicative of the measured temperature; and
providing backscattering from the microchip based on the signal indicative of the measured temperature, wherein the microchip is powered by the number of second AC signals.

11. The method according to claim 10, wherein the microchip is package-less and pad-less.

12. The method according to claim 10, wherein the microchip does not need AC to DC conversion or rectification to operate.

13. The method according to claim 10, wherein the number of first AC signals is each a 180 degree AC signal, and wherein the temperature sensor employs 180 degree-based AC logic.

14. The method according to claim 13, wherein the number of first AC signals is a single 180 degree AC signal, and wherein the number of second AC signals comprises two out of phase 180 degree AC signals V+ and V−.

15. The method according to claim 10, wherein the number of first AC signals is each an IQ quadrature AC signal, and wherein microchip employs IQ-based AC logic.

16. The method according to claim 15, wherein the number of first AC signals is a first IQ quadrature AC signal and second IQ quadrature AC signal, and wherein the number of second AC signals comprises four IQ quadrature AC signal VI+, VI−, VQ+ and VQ−.

17. The method according to claim 10, wherein the temperature sensor includes a band gap reference (BGR) oscillator and further comprising employing a feedback mechanism using a band gap reference (BGR) oscillator to accurately achieve a desired voltage amplitude in the microchip.

18. The method according to claim 17, wherein the feedback mechanism uses a microcontroller outside of the microchip.

19. A temperature sensing circuit, comprising:
a bang gap oscillator, wherein a frequency of the band gap oscillator is a function of a supply voltage amplitude of the circuit;
a first temperature sensor comprising a first oscillator with proportional to absolute temperature (PTAT) or complementary to absolute temperature (CTAT) characteristics, the first temperature sensor having a first temperature versus frequency slope;
a second temperature sensor comprising a second oscillator with proportional to absolute temperature (PTAT) or complementary to absolute temperature (CTAT) characteristics, the second temperature sensor having a second temperature versus frequency slope that is different than the first temperature versus frequency slope; and
a load switching circuit coupled to the bang gap oscillator, the first temperature sensor and the second temperature sensor, the load switching circuit being structured and configured to generate a number of backscatter signals indicative of the frequency of the band gap oscillator, a frequency of the first temperature sensor and a frequency of the second temperature sensor.

20. The temperature sensing circuit according to claim 19, further comprising a first edge detector coupled to the band gap oscillator for generating information indicative of the frequency of the band gap oscillator, a second edge detector coupled to the first temperature sensor for generating information indicative of the frequency the first temperature sensor, and a third edge detector coupled to the second temperature sensor for generating information indicative of the frequency the second temperature sensor.

21. A temperature sensing system, comprising:
the temperature sensing circuit according to claim 19; and
a controller located separately from the temperature sensing circuit, the controller being structured and configured to receive the number of backscatter signals and (i) determine a temperature value based on a ratio of the frequency of the first temperature sensor to the frequency of the second temperature sensor, and (ii) adjust an AC supply voltage that is supplied to the temperature sensing circuit based on the frequency of the band gap oscillator.

22. A temperature sensing method using a temperature sensing circuit, the method comprising:
generating a first oscillating signal having a first frequency that is a function of a supply voltage amplitude of the temperature sensing circuit;
generating a second oscillating signal having a second frequency from a first temperature sensor having a first temperature versus frequency slope;
generating a third oscillating signal having a third frequency from a second temperature sensor having a second temperature versus frequency slope that is different than the first temperature versus frequency slope; and
generating a number of backscatter signals indicative of the first frequency, the second frequency, and the third frequency.

23. The temperature sensing method according to claim 22, further comprising receiving the number of backscatter signals and (i) determining a temperature value based on a ratio of the second frequency to the third frequency, and (ii) adjust an AC supply voltage that is supplied to the circuit based on the first frequency.

24. An AC powered memory circuit, comprising:
a first bit line;
a second bit line;
a word line;
a first transistor directly coupled to the first bit line and the word line;
a second transistor directly coupled to the first bit line and the word line;
a third transistor and a fourth transistor connected in series, the third transistor and the fourth transistor being directly coupled to the first bit line, the third transistor being structured and configured to charge the first bit line and the fourth transistor being structured and configured to provide isolation; and
a fifth transistor and a sixth transistor connected in series, the fifth transistor and the sixth transistor being directly coupled to the second bit line, the fifth transistor being structured and configured to charge the second bit line and the sixth transistor being structured and configured to provide isolation;
wherein the third transistor and the fifth transistor are powered and driven by a number of AC signals.

25. The AC powered memory circuit according to claim 24, wherein the number of AC signals is each a 180 degree AC signal, and wherein the memory circuit employs 180 degree-based AC logic.

26. The AC powered memory circuit according to claim 25, wherein the number of AC signals comprises two out of phase 180 degree AC signals V+ and V−.

27. The AC powered memory circuit according to claim 26, wherein the third transistor is a PMOS transistor having a source, a gate and a drain, wherein V+ is received by the source of the third transistor and V− is received by the gate of the third transistor, wherein the fifth transistor is a PMOS transistor having a source, a gate and a drain, and wherein V+ is received by the source of the fifth transistor and V− is received by the gate of the fifth transistor.

28. The AC powered memory circuit according to claim 27, wherein each of the fourth transistor and the sixth transistor is a PMOS transistor, and wherein each of the first transistor and the second transistor is an NMOS transistor.

29. The AC powered memory circuit according to claim 24, wherein the number of AC signals is each an IQ quadrature AC signal, and wherein the memory employs IQ-based AC logic.

30. The AC powered memory circuit according to claim 29, wherein the number of AC signals comprises two IQ quadrature AC signal VI+ and VQ+.

31. The AC powered memory circuit according to claim 30, wherein the third transistor is a PMOS transistor having a source, a gate and a drain, wherein VI+ is received by the source of the third transistor and VQ+ is received by the gate of the third transistor, wherein the fifth transistor is a PMOS transistor having a source, a gate and a drain, and wherein VI+ is received by the source of the fifth transistor and VQ+ is received by the gate of the fifth transistor.

32. The AC powered memory circuit according to claim 31, wherein each of the fourth transistor and the sixth transistor is a PMOS transistor, and wherein each of the first transistor and the second transistor is an NMOS transistor.

33. The AC powered memory circuit according to claim 24, wherein each of the first transistor, the second transistor, the third transistor, the fourth transistor, the fifth transistor and the sixth transistor is a floating gate transistor.
